(19) United States
(12) Patent Application Publication
(10) Pub. No.: US 2006/0031078 A1
(43) Pub. Date: Feb. 9, 2006

(54) Method and system for electronically processing project requests

(76) Inventors: Barbara Pizzinger, Shoreham, NY (US); Joan Reilly, Dix Hills, NY (US); Louann Levine, Manalapan, NJ (US); Susan Kay White, Coral Springs, FL (US); Frank Cirisano, North Massapequa, NY (US)

Correspondence Address: KAYE SCHOLER LLP, 425 PARK AVENUE, NEW YORK, NY, 10022-3598, US

(21) Appl. No.: 10/910,844

(22) Filed: Aug. 4, 2004

(51) Int. Cl. G06Q 99/00

(52) U.S. Cl. 705/1; 705/8; 705/9

(57) ABSTRACT

A method and system are provided for handling electronic project requests, and more specifically to a system and method for electronically receiving, evaluating and processing project requests, and for monitoring the progress of developing requested projects through implementation. The system and method are directed to the submission and electronic processing of project requests, including: initiating a system request; directing the request to the appropriate business for review; generating cost and estimates for the requested project; generating preliminary start and end dates for the project; classifying the project based upon its size (cost expectations); acquiring funding for the project; and monitoring the project toward completion.

### FIELD OF THE INVENTION

The invention relates to systems and methods for handling electronic project requests, and more specifically to a system and method for receiving, evaluating and processing project requests, and for monitoring the progress of developing requested projects through implementation.

### BACKGROUND OF THE INVENTION

Businesses typically enter the marketplace to commercialize goods and/or services and to receive compensation in return for the provision of such goods or services. In the course of commercializing their goods or services, businesses often implement various operations to handle day-to-day activities. These operations relate to functions, such as manufacturing, marketing, accounting, and the like. Oftentimes, such operations require that businesses establish the appropriate protocols and systems to effectuate their business activities.

As a business grows in size or complexity, the need for such protocols and systems increases. It is not uncommon for an organization to field one or more new project requests each business day respecting such protocols and/or systems. Typically, these requests are submitted manually and in an ad hoc manner (i.e., without any system in place), are processed manually, and are monitored manually by the project requesters and those processing the requests. When there are a large number of projects and a large number of people involved in making project requests and processing projects, the manual effort often becomes inefficient and sometimes ineffective.

### SUMMARY OF THE INVENTION

The invention addresses this problem and relates to systems and methods for handling electronic project requests, and more specifically to a system and method for electronically receiving, evaluating and processing project requests, and for monitoring the progress of developing requested projects through implementation.

With such a system and method, a business automates certain aspects of the submission, reception and monitoring of a request. In addition, communication between business units and individual employees is made more efficient by the project initiation and monitoring system. For example, the likelihood of a bottleneck is reduced as the flow of project information flows effectively.

Financial oversight of requested projects is improved as new projects and project ownership changes are monitored for appropriate authorization. In addition, useful financial analyses may be performed by estimating project costs prior to project initiation and comparing the estimate with actual financial data respecting the project after its completion. Such estimates and actuals are useful for estimating funds required for subsequent projects, and for evaluating the efficiency of a project and/or the efficiency of personnel responsible for processing the project.

In accordance with an embodiment of the invention, a system and method are provided for categorizing a project defined by a project request. The system and method include receiving a first value associated with processing a project request and a second value associated with determining the first value, and then calculating, by a processor, a total processing value for completing the project request, wherein the total processing value is based, at least in part, upon the first value and the second value. The project request is then categorized based, at least in part, upon the total processing value.

In accordance with another embodiment of the invention, a method and system for evaluating a request to process a project are provided, wherein the request includes information relating to processing the project. The method and system include receiving a score relating to a level of detail included in the request and determining, by a processor, a project-related date based, at least in part, upon the score.

In yet another embodiment of the invention, a method and system are provided for monitoring the processing of a project, wherein the project is defined by a project request. The method and system include receiving a first value associated with processing the project request and a second value associated with determining the first value, and comparing, by a processor, the second value with an estimated sizing value, wherein the estimated sizing value relates to an estimated value for determining the first value. The comparison information is then stored, wherein the comparison information is based, at least in part, upon comparing the estimated sizing value with the second value.

In a further embodiment of the invention, a method and system for monitoring the processing of a project are provided, wherein the project is defined by a project request. The method and system include receiving a first value associated with processing a project and comparing, by a processor, the first value with an estimated processing value, wherein the estimated processing value relates to an estimated value for processing the project request. The comparison information is then stored, wherein the comparison information is based upon the comparing of the estimated processing value with the first value.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1 is a block diagram of an electronic project request processing system that incorporates features of the present invention for receiving project requests and processing received project requests, in accordance with an embodiment of the invention;

FIGS. 2A-2C are tables illustrating examples of types of data stored in and used by the system of FIG. 1;

FIGS. 3A-3C illustrate an example of a graphical user interface (GUI) of a project initiation request form utilized in conjunction with the system of FIG. 1;

FIG. 4 is a flowchart illustrating an example of a method of receiving a project initiation request;

FIG. 5 is a flowchart illustrating an example of a method of reviewing the project initiation request;

FIG. 6 is an example of a report, generated by the system of FIG. 1, listing accepted and rejected project requests, generated by FIG. 1;

FIG. 7 is a flowchart illustrating an example of a method of sizing a project of a received project initiation request;

FIG. 8 is an example of a sizing report, generated by the system of FIG. 1;

FIG. 9 is a flowchart illustrating an example of a method of authorizing the funding for a requested project;

FIG. 10 is a flowchart illustrating an example of a method for monitoring the completion of an authorized project;

FIG. 11 is an example of a report, generated by the system of FIG. 1, for comparing actual hours required versus sizing hours estimated for processing a project request, generated by FIG. 1;

FIG. 12 is an example of a sizing tracking report generated by the system of FIG. 1; and

FIG. 13 is a table identifying various GUI views available to users and/or administrators having access to the system of FIG. 1.

### DETAILED DESCRIPTION

In an embodiment of the invention, the invention relates to systems and methods for processing electronic project requests, and more specifically to a system and method for electronically receiving, evaluating and processing project requests, and for monitoring the progress of requested projects through implementation. The system and method is directed to the submission and electronic processing of project requests, including: initiating a system request; directing the request to the appropriate business for review; generating cost estimates for completion of the requested project; generating preliminary start and end dates for the project; classifying the project based upon its size (for example, development hours, cost expectations, etc.); acquiring funding for the project; and monitoring the project development toward completion.

The System

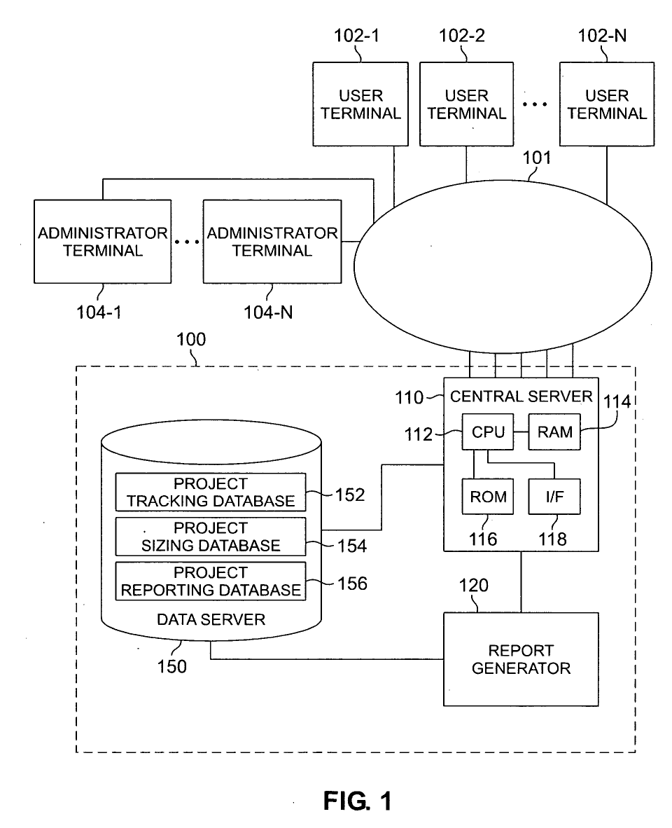

FIG. 1 is a block diagram illustrating an electronic project processing system 100 that incorporates features of the present invention. System 100 handles the receipt, authorization, sizing, funding and monitoring of requested projects generated by user terminals 102-1 to 102-N. As shown in FIG. 1, various components are involved in the initiation and execution of such electronic project processing—namely, user terminals 102-1 to 102-N, administrator terminals 104-1 to 104-N, central server 110, report generator 120 and data storage 150. (The function of each of these components and their interaction are described below.)

It should be noted that, in an aspect of the invention, a user is typically a requester, business manager, developer, or some other person that is either involved in submitting a project request, is responsible for approving or authorizing a project request or is impacted by a project request. An administrator is an individual that is responsible for processing the project request and may include, for example, a project process liaison (PPL)—i.e., an individual who manages the processing of a project request.

Central server 110 is centrally located to support communication, via network 101, among user terminal 102-1 to 102-N, administrator terminals 104-1 to 104-N, report generator 120 and data storage 150 for receiving and processing project requests.

Although FIG. 1 illustrates a system comprising central server 110, report generator 120 and data storage 150 for handling project requests (including receipt, authorization, sizing, funding and an monitoring of requested projects), the functionality of the system of FIG. 1 described herein may be performed by any number of servers, including a single server, the servers shown, or more servers. Central server 110 and report generator 120 may therefore be separate processing devices as illustrated in FIG. 1, or may be combined into a single device. Server 110 and report generator 120 may be a mainframe, server, computer or some other device having computing capability and are configured for communicating with one another as well as terminals 102-1 to 102-N, 104-1 to 104-N described herein.

Central server 110 preferably includes standard hardware components, such as central processing unit (CPU) 112, a random access memory (RAM) 114, a read only memory (ROM) 116 and interface (I/F) 118. CPU 112 is preferably linked to each of RAM 114, ROM 116 and I/F 118, either by means of a shared data bus, or dedicated connections, as shown in FIG. 1.

CPU 112 may be embodied as a single commercially available processor. Alternatively, the CPU 112 may be embodied as a number of such processors operating in parallel.

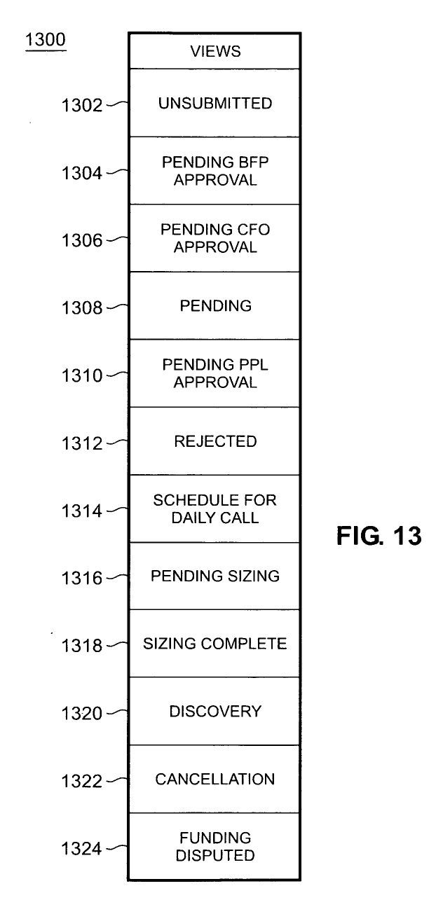

ROM 116 is operable to store one or more instructions, discussed further below in conjunction with FIGS. 1-13, which the CPU 112 is operable to retrieve, interpret and execute. For example, ROM 116 preferably stores processes for initiating project requests, authorizing the project initiation request, sizing the requested project, authorizing the funding for a requested project, and monitoring the completion of the authorized project, in the form of software, for example.

CPU 112 preferably includes a control unit, an arithmetic logic unit (ALU), and a CPU local memory storage device, such as, for example, a stackable cache or a plurality of registers, in a known manner. The control unit is operable to retrieve instructions from ROM 116. The ALU is operable to perform a plurality of operations needed to carry out instructions. The CPU local memory storage device is operable to provide high-speed storage used for storing temporary results and control information.

I/F 118 connects central server 110 to report generator 120 and data storage 150. I/F 118 further allows for communication, via for example network 101, with central server 110 by user terminals 102-1 to 102-N and administrator terminals 104-1 to 104-N. Such connection may be by means of direct connection or network.

In accordance with an embodiment of the invention, report generator 120 comprises the same type of components as central server 110. Thus, CPU, RAM, ROM and interface devices—similar to components 112, 114, 116 and 118, respectively—as described above are incorporated in such servers. Report generator 120, however, preferably stores instructions/processes for the generation of different types of project reports as requested by user terminals 102-1 to 102-N or administrator terminals 104-1 to 104-N.

Central server 110 and report generator 120 are in communication with data storage device 150. Data storage device 150 contains one or more databases including, in one example, project tracking database 152, project sizing database 154 and project reporting database 156.

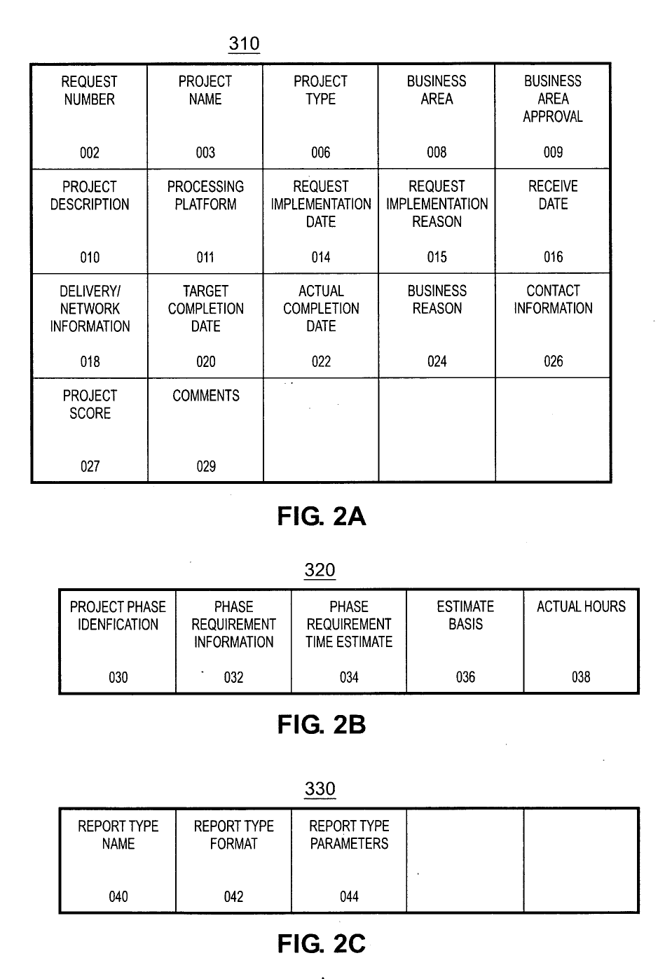

Project tracking database 152 preferably stores information relating to the following project request information (which is illustrated in table 310 of FIG. 2A): request number 002, project name 003, project type 006, initiating business area 008, business area approval 009, project description 010, processing platform 011, requested implementation date 014, request implementation reason 015, receive date 016, delivery/network information 018, target completion date 020, actual completion date 022, business reason 024, contact information 026, project score 027 and comments information 029. It should be noted that the 310 (as well as tables 320 and 330) simply provide a representation of the data that may be used by system 100, in one or more embodiments of the invention; it is not a representation of data that is necessarily stored by one or more of databases 152, 154 and 156.

Request number 002 is an identification number which is assigned to each project that is accepted for processing and is used for identifying each project that is to be processed by system 100. Another project identifier is project name 003. Such name is typically descriptive of the requested project and is provided by the user that submits the request.

Project type 006 relates to the type of project that is requested by the user. In accordance with an embodiment of the invention, various project types may be initiated, including: Quick Hit projects which are projects that can be completed in less than a predetermined number of person hours, such as 40 hours; Top Ten projects which are projects that a business unit considers to be its most important projects that require more than 40 hours, but less than 1360 hours, of development effort to complete the project (in one example, the number of most important projects can be changed from ten to a smaller or larger quantity); and Major projects which are projects that are approved by senior management of an organization (these projects typically require 1360 hours or more of development effort or incur labor costs in excess of $100,000, for example).

Initiating business area 008 is the business division or department from which the request is initiated. Preferably, this data also includes information relating to the identification of at least one initiating area senior manager. Senior manager identification may be used for, for example, to identify the CFO or some other individual from which approval may be sought, whereas the identification of the initiated business area may be used for tracking the number of Top Tens generated by the business area, for example. In addition, business area approval data 009 is information relating to one or more business areas that are to be notified prior to processing the project initiation request.

Project description data 010 relates to information that describes, preferably in detail, the project that is being requested and is typically provided by the requestor.

Processing platform data 011 is information for identifying which computer system(s) of a business are to be dedicated to processing a submitted project request. In one example, platform selection may be based upon the processing needs required to complete a project. For example, a more complex project may require access to a platform that has large amount of processing capability. In accordance with another example, a given platform may be dedicated to certain businesses and therefore a platform dedicated to the business initiating the project request is selected.

A requestor may submit a date by which the request shall be implemented. Such information is stored in requested implementation field 014. When such a date is provided, the requestor is required to provide the reason 015 that the request must be implemented on or before the requested implementation date.

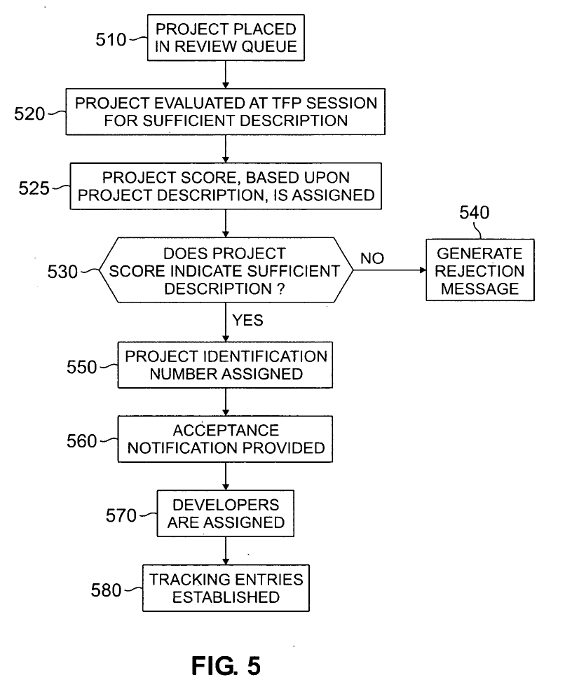

Receive date 016 identifies the date and time that a project initiation request is received and accepted (as described more fully below with respect to FIG. 5) by central server 110.

Delivery/network information 018 identifies the mode of delivering and outputting projects. For example, a user may specify where project files are to be transmitted, the frequency of such transmission, whether hard copies of reports are to be generated, the format of such reports and the like.

Target completion date data 020 is information relating to the date by which the project is expected to be completed, and actual completion date data 022 is information relating to the date that project development for a given project is actually completed.

Business reason 024 includes information that explains why the project is required by or is helpful to one or more business units. Contact information 026 identifies one or more individuals that submit a project request, are ultimately responsible (financially or otherwise) for the completed project and/or develop/implement the project.

Project score data 027 includes information for scoring a project initiation request. For example, in accordance with an embodiment of the invention, requests may be designated with a score of an A, C, D or F. A project request that includes information responsive to the required fields and also provides all details required to process the project request receives an A. Requests that are scored with an A are processed in a relatively short amount of time, such as seven days.

A project request that provides information responsive to the required fields and includes sufficient information to process the request, even though some level of detail is omitted, is scored a C. Project requests requiring additional detail and therefore scored with a C rating, typically require more time to be processed—for example, fourteen days—as compared with those projects that receive an A rating.

Project requests that do not include sufficient information for processing and therefore require significant development to formulate the requirements are designated with a score of D. In accordance with an embodiment of the invention, such requirement formulation is accomplished by a process called “discovery.” In order to initiate the discovery process, the description provided by the project request must include, in one example: (1) a pre-approved number of hours to spend on the discovery process; (2) a date by which the discovery process must be complete; and (3) the desired outcome of the discovery process—for example, a PIR form having sufficient detail to warrant a score of an A or C, a document that assists technical business areas in understanding processing changes, training impacts, etc.

A project initiation request that fails to provide sufficient information to allow for the processing of the request or initiate the discovery process receives an F. As described below, such a score results in a message being sent to the requestor that additional information is required before processing can be initiated.

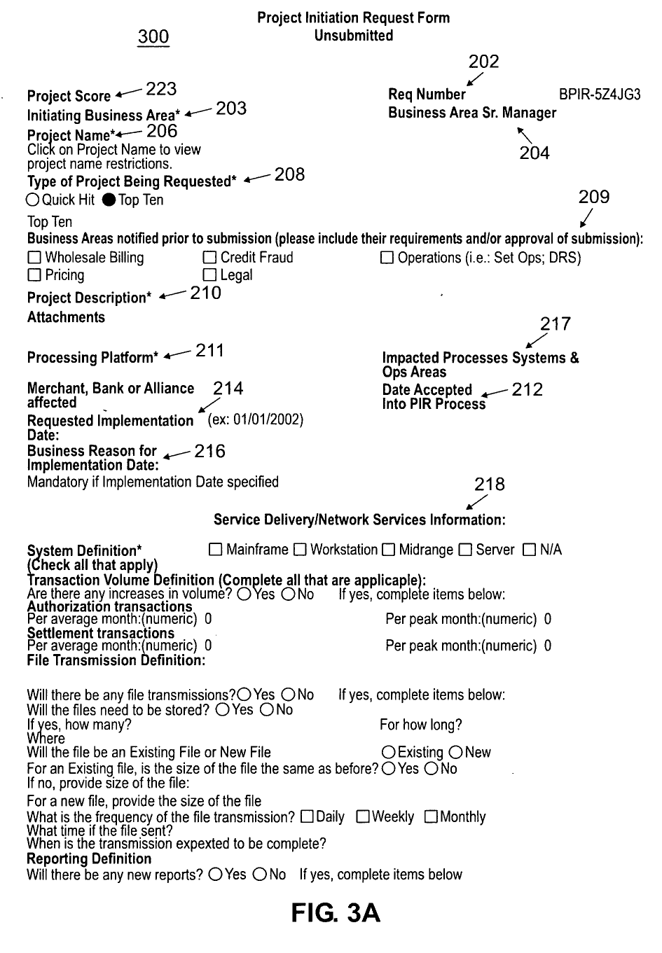

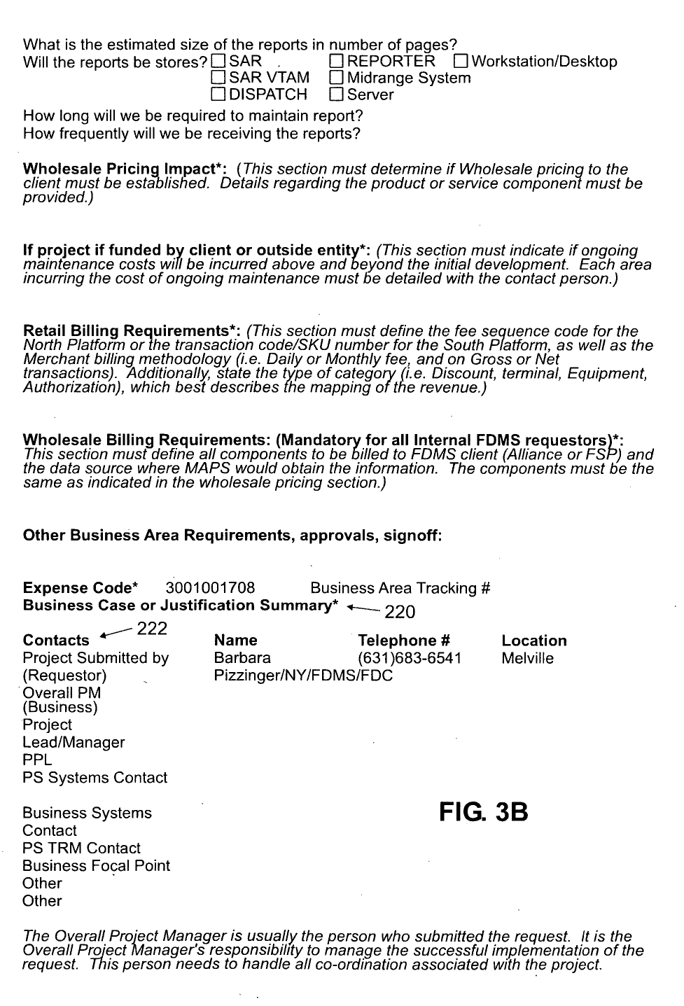

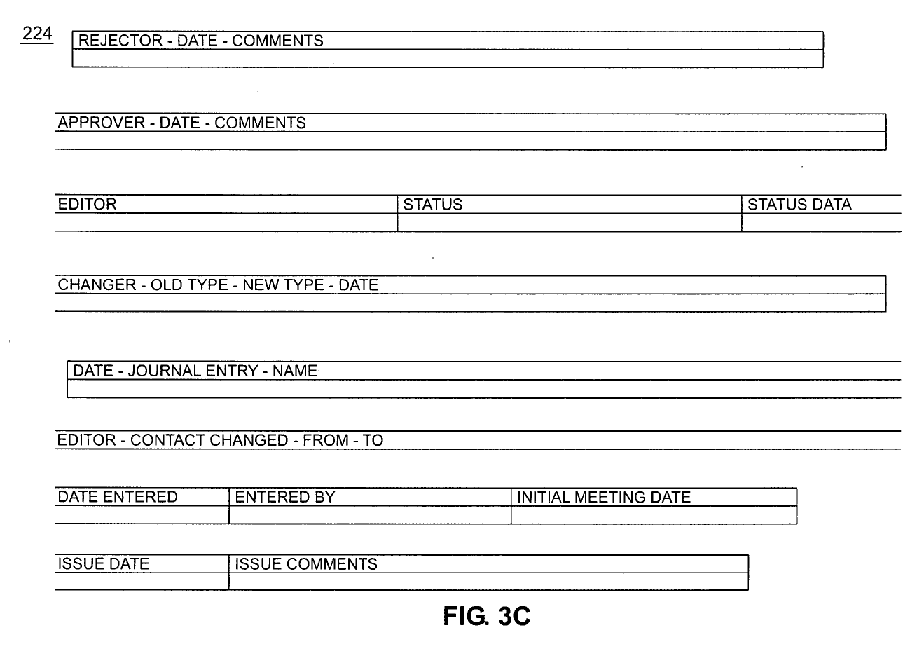

Comments data 029 includes information that may be provided and/or accessed by the requestor or anyone else who has access to a given PIR form, and is described more fully below with reference to the comments field 224 of FIG. 3C.

Project sizing database 154 stores information (examples of which are illustrated by table 320 of FIG. 2B) relating to the phases and resources required to complete a project, including: project phase identification 030, which includes descriptive information regarding one or more phases of a project; project tracking entry information 032, which identifies the step(s) required to effectuate a project phase; project entry time estimate 034, which is an amount of time that is estimated for completing a corresponding project phase; estimate basis 036, which relates to information that forms the basis for a corresponding phase requirement time estimate (such as prior project history); and actual hours information 038, which identifies the actual number of person hours that are ultimately applied to complete a given project phase requirement.

Project reporting database 156 preferably stores information (as illustrated by table 330 of FIG. 2C) relating to the output of project reports to users accessing user terminals 102-1 to 102-N, or administrators via administrator terminal 104-1 to 104-N. Such data includes: report type name 040 (such as, Pending Top Ten's, Pending Quick Hits, Summary of All Projects by Business Area (for a given time period), List of Completed Projects (for a given time period), and the like, report type format 042 which relates to the graphical user interface for available reports, and report type parameters 044 which relate to the data fields required to prepare a requested report.

As data from data storage 150 is received by system 100, central server 110 directs the data to data storage 150 for storage by the appropriate database(s) 152, 154, 156. In addition, as data is accessed by one or more of central server 110 or report generator 120, for processing by one or more of these devices or for transmission to user terminals 102-1 to 102-N or 104-1 to 104-N, the required data is accessed from databases 152, 154, 156 via data storage 150.

Central server 110 is configured to receive project requests, and authorize, approve funding for, size and monitor development of requested projects. In addition, report generator 120 is configured for outputting reports regarding requested projects. These processes are described more fully below with reference to FIGS. 1-13.

Initiating a Project Request

Processing a project begins with the receipt of a project request by a requester. For example, an electronic Project Initiation Request Form (also called a “PIR form”)—which is a written explanation of a desired systems implementation or change and the business justification for such implementation/change—is completed and submitted to system 100 to initiate a project request. Thus, a requester at, for example, user terminal 102-1 of system 100, can make a request to have a PIR form GUI displayed at terminal 102-1. PIR form 200, as illustrated by FIGS. 3A-3C, provides a summary of the project, and includes, among other things: a brief description of the requested project, a statement of why the project is needed, the financial benefit of the project, systems impact caused by the project, critical dates (such as requested implementation date) and contact information (such as, at a minimum, information regarding the requester).

An example of PIR form 200 is illustrated in FIGS. 3A-3C. For instance, PIR form 200 may be displayed by selecting a link offered as part of a Lotus Notes interface with the user. Of course, various other types of applications and displays may be implemented to allow a user to make a project request.

Turning to FIGS. 3A-3C, PIR form 200 comprises various prompts for inputting information by a user and corresponding fields for receiving such input. For example, request number prompt/field 202 allows system 100 to provide a request number 002 for each request made by a user of system 100. This identifier is typically assigned by CPU 112 of system 100 after PIR form 200 is submitted by the requester.

PIR form 200 requires that the initiating business area be identified in initiating business area field 203. As described above, the initiating business area is the business unit or department that is requesting or funding the project initiation request. Although not required, a manager having authority to approve the submission of PIR request 200 is identified in business area senior manager field 204.

The next fields to be completed by the requestor are project name field 206, which is filled with project name data 006, and project type field 208, which is filled with project type data 008. The project name 006 may be used to assist in identifying a given project when a user, administrator, etc. desires to access a project in process or a completed project. The project type 008 allows a user to designate the type of project that is being requested (for example, Quick Hit, Top Ten, etc.). As described more fully below, such designation, in accordance with an embodiment of the invention, affects the processing of the project with regards to, for example, authorizations that are required, the designated time to complete the project, etc.

PIR form 200 also requires that a user populate processing platform field 211 with processing platform data 011 so that the appropriate computing resources may be designated for completing the requested project.

In addition, PIR form 200 provides for an acceptance date field 212 which identifies when PIR form 200 is received by central server 110. In one example, received date information 016 (which is supplied in field 212) simply relates to the date that PIR form 200 is submitted by the requester and received by central server 110. In another example, received date information 018 relates to when PIR form 200 is received and accepted by central server 110—for example, when the project request is evaluated and designated with a score of A, C or D.

PIR form 200 also allows the requestor to input a requested implementation date 014 in requested implementation date field 214. This information is optional and, when provided, must be presented along with a business reason for such implementation date. The implementation date reason data 015 is provided in field 216 and is used by system 100 when determining whether the project processing should be scheduled to be completed prior to a default time of, for example, seven or fourteen days.

PIR form 200 also prompts a requestor to input the impact that the requested project—once completed—will have on one or more business units at impacted processes systems and operations area field 217. In addition, the requestor is required to provide, in business case or justification summary field 220, business reason data 024—which is the justification for the project that is being requested. Such impact (field 217) and justification (field 220) information is used for determining whether a requested project should be approved.

In addition, PIR form 300 allows a requestor to provide service delivery and network information in section 218. The delivery and network information identifies the mode of delivering and outputting projects, and may include where project files are to be transmitted, the frequency of such transmission, whether hard copy of reports are to be generated, the format of such reports and the like.

As illustrated by FIG. 3B, contact information 026 for individuals involved with a requested project is prompted by fields 222. Contact information fields 222 allow for provision of one or more contact's title, name, telephone and location.

Finally, as illustrated by comments fields 224 of FIG. 3C of PIR form 200, comments may be stored in an organized manner such that the user of form 200 can input and/or access comments relating to rejection, approval and changes to PIR form 200, as well as any other comments which may be inputted in, for example, a journal section of comments field 224 for tracking activity relating to a project initiation request.

Once the requestor has completed at least the “mandatory” fields of PIR form 200 (as illustrated by FIGS. 3A-3C), PIR form 200 is ready for submission to central server 100 for processing the project initiation request. To avoid delays downstream, each mandatory field should be completed prior to submission of PIR form 200 to central server 110.

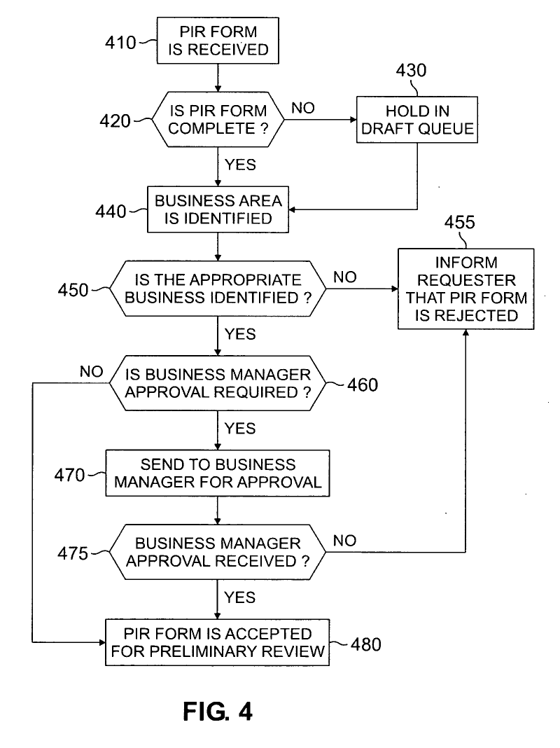

The process of initiating a project request is illustrated with respect to FIG. 4. At step 410, PIR form 200 is submitted by a requester from a terminal, such as user terminal 102-1, and is received by central server 110 via I/F 118. The data fields of PIR form 200 are read and a determination is made by central server CPU 112 as to whether each of the data fields that are designated mandatory are completed. If, at step 420, CPU 112 determines that one or more of the mandatory fields have not been completed by the requester, the project request is given a score of F, processing of the project request is suspended and PIR form 200 is held in draft queue until PIR form 200 is completed at step 430. When data fields which are designated mandatory are not completed, a message is also sent from central server 110 to user terminal 102-1 indicating that such information has not been provided and that the request is held in draft queue—or project tracking database 152.

Once all of the mandatory fields of PIR form 200 have been completed, CPU 112 then identifies the business area for which the initiated project is to be processed at step 440. This is accomplished, for example, by reading the submitted data from requesting business area field 218.

A determination is then made (at step 450) as to whether the appropriate business is identified. Such determination is typically accomplished by having an individual that has access to system 100 whose function is to be a “gatekeeper” for projects within a given business unit and who keeps track of all of the unit's projects and their status by accessing system 100 via terminals 104-1 to 104-N. Such individual is referred herein as the “business focal point” or “BFP.” If the BFP determines that a requested project is not appropriate for the business unit, PIR form 200 is rejected and the requester is informed of the rejection, at step 455.

If, however, the BFP determines that the requested project is appropriate for the business unit, a business manager approval process (if required) is initiated.

Whether the business manager approval process is required depends upon, in one example, the project type. For example, projects such as Major projects that exceed a certain estimated cost must receive management approval. Depending on the project type (and in particular the project cost), several levels of business management approval may be required. Often, the business reason is also considered when business management approval is sought.

If, at step 460, it is determined that no business management approval is required, PIR form 200 is accepted by CPU 112 of central server 110, at step 480. If, however, business management approval is required, then CPU 112 sends a message to the appropriate business manager(s) (i.e., one or more business manager(s) identified in PIR form 200) requesting such approval, at step 470.

Such business management approval request (when required) is, for example, made automatically upon submission of PIR form 200. This may be done by sending an e-mail to the appropriate business manager, with a copy to the requester, wherein submitted PIR form 200 is attached to the e-mail.

At step 475, CPU determines whether business management approval has been received. If business management approval is provided, PIR form 200 is accepted by CPU 112 of central server 110, at step 480. If, however, no business management approval is provided, at step 475, central server 110 rejects the project request and a notification is sent to the requester, at terminal 102, advising of the rejection of the project request, at step 455.

Project Request Review and Confirmation

Once PIR form 200 is accepted, at step 480, it is then given a preliminary review for the assignment of appropriate project processing resources. This process is described with reference to FIG. 5.

At step 510, accepted PIR form 200 is placed in a review queue such that it can be evaluated by the technical focal point (TFP). The TFP (1) ensures that new project submissions are reviewed in a timely manner, (2) determines the sufficiency of the project description and requirements, and (3) identifies groups (i.e., developers) that will need to work on the project and identify a technical lead person based upon the preliminary assessment of the technical work involved.

Thus, at step 520, the TFP that is assigned to a project request evaluates the information provided to central server 100 via PIR form 200 submitted by the requestor, and determines, at step 530, whether the request contains sufficient description and requirements to process the project. If the project request does not contain a sufficient description and requirements, the TFP causes a rejection message to be generated by CPU 112 and delivered to the requester's user terminal 102, at step 540. Along with the rejection message is an explanation which sets forth the reason(s) that the project request was rejected.

If, on the other hand, sufficient description/requirements are provided, CPU 112 then generates project number identifier 002, at step 550, which is associated with the project and generates a notification which is sent to requester's user terminal 102 indicating that the project has been accepted, at step 560.

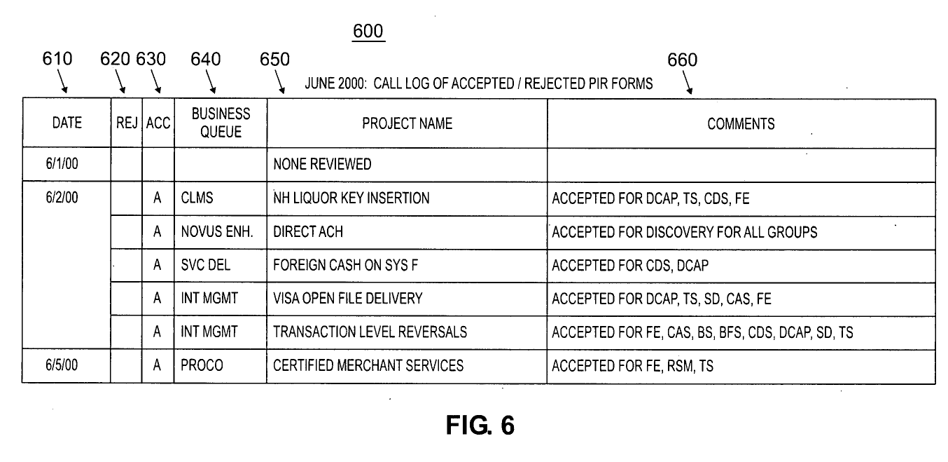

In addition, the project is added to a list of accepted and rejected PIR forms which covers a predetermined period of time—for example, a given month period of time. FIG. 6 illustrates report 600 which indicates a monthly call log of accepted and rejected PIR forms during the first five days of June 2000. In this example, report 600 has six columns: column 610 shows the date that a PIR form is rejected or accepted; columns 620 and 630 indicate which reports have been rejected and accepted, respectively; columns 640 and 650 indicate the business group requesting a project and the name of the project that is accepted or rejected, respectively; and column 660 provides comments regarding project acceptance or rejection. Report 600 indicates that: on June 1, no project requests were reviewed and accepted; on June 2, five project requests were reviewed and accepted; on June 5, one project request was reviewed and accepted. The report also includes the project name and comments for each project. This report may be used to identify the project requests that have been most recently submitted to assist in ensuring that developers are being assigned and tracking entries are being established.

Returning to FIG. 5, once a project is evaluated and assigned a project number, and notification is sent to the contacts listed in PIR form 200, project developers are then assigned to the project, at step 570. Developers are assigned by first identifying the type of technical resources that are required to process the request. Such identification is typically managed by the TFP. Once the TFP determines which developers are involved, project tracking entries 032 are identified by the TFP and stored by project sizing database 154, at step 580. Project tracking entries are listed benchmarks which are used to track the number of hours that are spent on a project. Such entries include the number of hours spent on processing the project request. Thus, the first project tracking entry of each project typically relates to processing the project request itself.

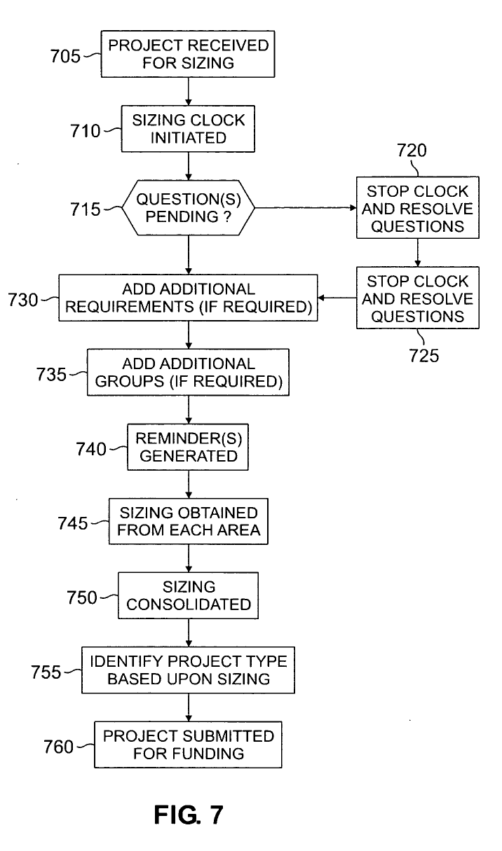

The next process is “sizing” the project for the number of person hours required to complete the project and to identify target start and completion dates. This process is further described below with reference to FIG. 7.

Sizing A Project

FIG. 7 illustrates a flowchart for sizing an accepted project. Once a project request has been accepted, the project is then received for sizing, as indicated by step 705. This is accomplished by submitting a sizing request to central server 110.

The submission of a project request for sizing initiates a clock or timer, which tracks the amount of time that has transpired since the sizing process was initiated and how much time is left before a preset sizing deadline is met, at step 710. In accordance with an embodiment of the invention, all projects that are submitted for sizing, in which the project request received a score of A, receive a seven day default turnaround time, for example. The seven day sizing time can be altered but, in one aspect of the invention, requires that a reason be provided for delaying or expediting the sizing process. If, in accordance with an embodiment of the invention, the project request receives a score of C, the sizing time may increase to, for example, fourteen days.

Central server 110 also monitors for instances in which the sizing process is interrupted due to the necessity for additional information. Thus, central server 110 determines (at step 715) whether, at any point during the sizing process, questions arise that require additional information in order for the sizing process to continue. If such questions arise, the sizing clock is stopped and the questions are resolved, at step 720. This may be accomplished, for example, by sending a stop clock request to central server 110, which in turn requests submission of the pending question(s). These questions are then forwarded by central server 110 by, for example, email to the BFP assigned to the project. In one instance, the sizing clock is only stopped when there is a question relating to the project request (as opposed to the technical questions regarding the sizing procedure). Once the questions are resolved, at step 725, sizing continues and the clock is restarted. It should be noted that questions can arise at multiple points during the sizing process. In such cases, the sizing clock may need to be stopped two or more times. When the clock is stopped, however, it is not reset to zero. Thus, when it is restarted, the clock continues to measure time from where it left off prior to the stoppage.

During the sizing process, central server 110 monitors for requests of additional requirements, at step 730, or for the need to involve additional technical groups, at step 735. If an additional requirement is required, the sizing process is terminated and the BFP for the project is contacted (typically by email) for the submission of the additional information.

If additional groups are required, then central server 110 sends a notification to each additional technical group that is required to effectuate the sizing. It should be noted that, in one example, each time a new technical group is added to the sizing process, the clock for that group begins at day 1 (even though the project may be days into the sizing process).

Central server 110 also keeps track of the number of days that have transpired since the sizing process began. Thus, when a predetermined number of days prior to the sizing deadline is reached (for example four days before and one day before the fourteen day deadline), a reminder is generated by central server 110 informing the developers that are sizing the project of the upcoming deadline, at step 740.

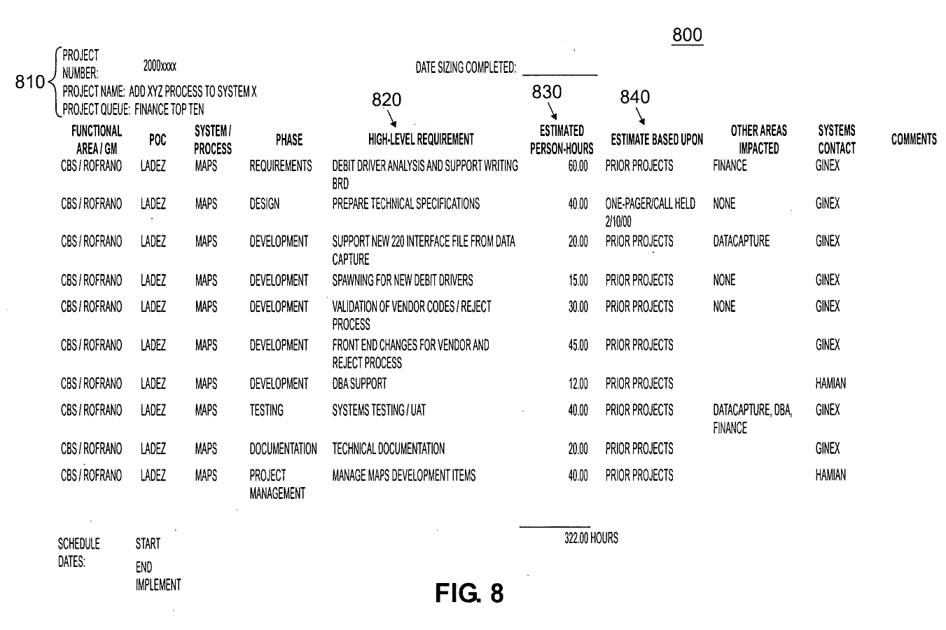

At step 745, central server 110 next obtains the sizing from each technical group or area and then consolidates the collected sizing information, at step 750, to form a sizing template for a requested project. An example of a sizing report (report 800) is illustrated by FIG. 8.

As illustrated by report 800 of FIG. 8, a project is identified by identification information 810, including the project's request number 002 and project name 003. In addition, various high level requirements, or tracking entries 032, are listed in column 820 along with the project entry time estimate 034 in column 830—i.e., the number of hours that is expected for completion of the listed entry. In addition, report 800 identifies the basis 036 associated with each time entry, in column 840. Such reports serve as a useful tool for arriving at an overall value for a given project and for identifying which business areas are impacted by the project.

With the total hours accumulated for the requested project, central server 110 then identifies the project type (for example, Major, Quick Hit, Top Ten, etc.) based upon the sizing, at step 755, and the project is submitted for funding, at step 760, based upon the project type. In accordance with an embodiment of the invention, project type may be based upon development costs, rather than the number of hours to complete the project. Development costs are calculated by multiplying the number of hours for completing each listed entry of a project by the rate of the developer(s) assigned to process the entry, and then totaling the resultant products.

Funding the Project

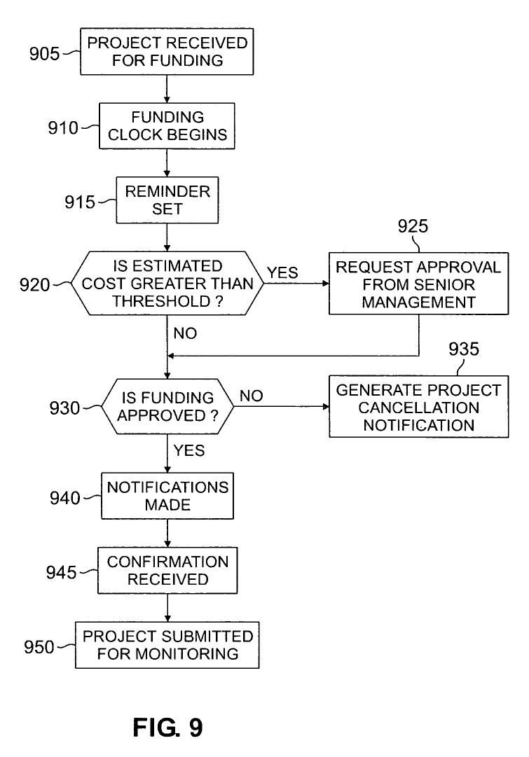

Once the sizing process is completed, funding approval is then reviewed for approval by the business unit that submitted and authorized the project request. An example of a process of funding the project is illustrated in the flowchart of FIG. 9.

Projects that have been sized are ready for funding approval. Accordingly, such projects are submitted by central server 110 with a request for funding, at step 905. It should be noted that not all sized projects necessarily require funding approval. For example, in accordance with an embodiment of the invention, projects whose sizing yields fewer than a predetermined number of person hours to complete the project (typically Quick Hits) do not require funding approval. Larger projects (such as Major projects and Top Ten projects), however, typically require funding approval.

Funding approval comes from the business unit that submitted the project request and is typically directed to the BFP listed in PIR form 200. Thus, central server 110 transmits a request for funding approval to the BFP's terminal (for example, terminal 102-1) and may be effectuated by email which generates a request for funding approval and attaches the completed consolidated sizing sample for the requested project, such as report 800 of FIG. 8.

Upon submitting the funding request to the BFP, a funding clock is initiated, at step 910. In an aspect of the invention, the clock is set to fourteen days (although this number can vary). Thus, the BFP has fourteen days to respond to the funding request. A delayed response will usually delay the scheduled starting and ending time for processing and completing a project. If, however, the BFP attains the necessary approvals within the predetermined period of time, then the scheduled project start and end times are expect to be met.

Similar to the sizing clock, at step 915, the funding clock monitors the time that has transpired since the funding request is submitted by central server 110 and generates a reminder at predetermined times—for example, four days and one day prior to the fourteen day sizing deadline.

Next, at step 920, a determination is made as to whether the development costs for the sized project exceeds a predetermined threshold. Such threshold may be set at, for example, $100,000, $1,000,000, $3,000,000, etc. If the development costs are less than such predetermined threshold, central server CPU 112 awaits for a funding approval message from the BFP.

If, however, the approval amount exceeds the predetermined threshold, one or more senior management (for example, CFO, business president, etc.) authorizations must be sought, at step 925, and then central server CPU 112 awaits for funding approval from senior management (as opposed to the BFP).

When CPU 112 receives a message regarding funding approval, it determines whether the funding is approved, step 930. If funding is not approved, CPU 112 generates a project cancellation notification to the contacts listed on PIR form 200, step 935, and the project is aborted. If, however, CPU 112 determines that the project funding is approved, notifications of such approval are made to all developers involved in developing the project with a copy to the contacts listed on PIR form 200, at step 940. The BFP who is copied on the notification is requested to confirm that the project can go forward, at step 945. Once the notifications are made by central server 110 and the confirmation is received, the project initiation process is complete and the project is implemented. At this point, project processing is ready to be monitored by system 100, step 950.

Monitoring the Project

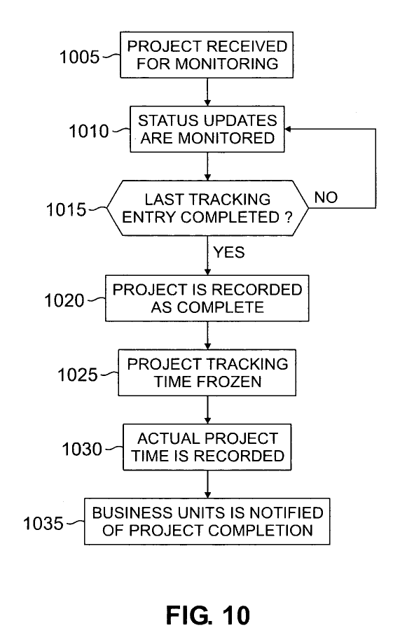

Although project initiation is completed when the project funding is approved and communicated to the appropriate parties, system 100 monitors the final step of processing a project through completion. This process is the project monitoring phase and an example of which is illustrated by the flowchart of FIG. 10.

Thus, at step 1005, CPU 112 of server 110 requests certain project information from project sizing database 154. Such information includes the start date, end date, tracking entries and estimated hours for the project. The project is monitored at predetermined intervals, at step 1010—such as on a daily basis. The BFP is notified at the same interval of the project status and any issues that have arisen (if any).

CPU 112 monitors the project to determine whether the last tracking entry has been completed, at step 1015. If the last tracking entry has not been completed, CPU 112 continues to monitor the project, at step 1010. Once CPU 112 has determined that the last tracking entry has been completed, the project is marked as complete, at step 1020, the project tracking time is frozen, at step 1025, the actual time for each tracking entry is recorded, at step 1030, and the impacted business units are notified that project is completed, at step 1035.

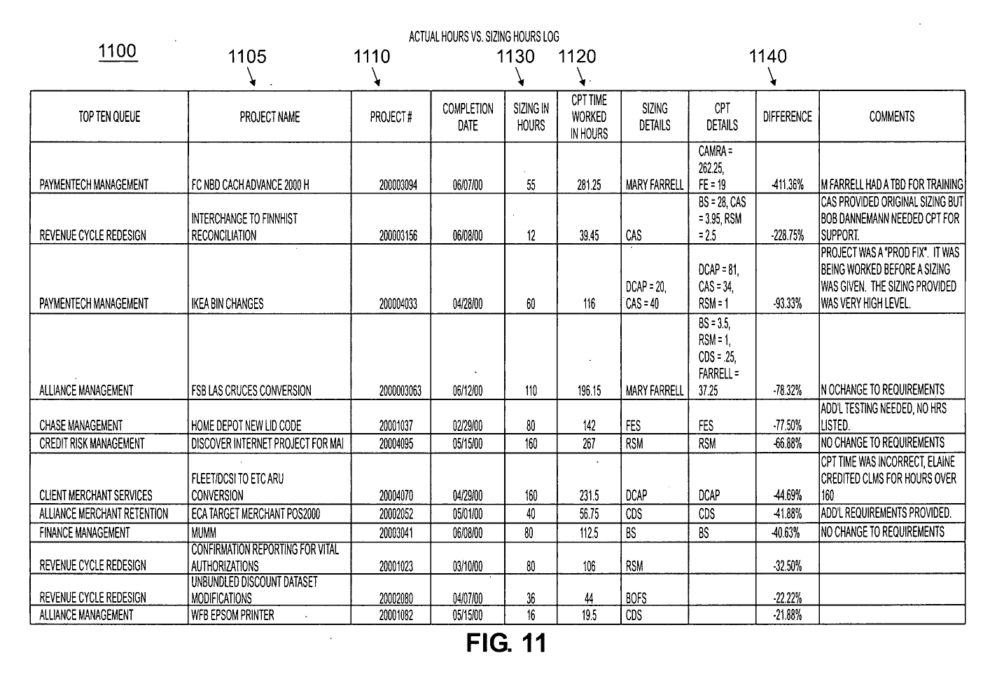

A report may then be generated which compares the sizing estimates with the actual time information for each tracking entry. An example of a sample report 1100 showing such a comparison may be found at FIG. 11. In this report, for example, actual working hours for a given project (the project being identified by name (column 1105) and number (column 1110)) are identified in column 1120, and the estimated sizing hours are provided in column 1130. The comparison of these figures is provided in column 1140. In addition to analyzing the actual hours spent on the project as compared to the size hours, an analysis of the timeliness of the project completion may be performed. Such analysis compares the target completion date for a given project with the actual completion date.

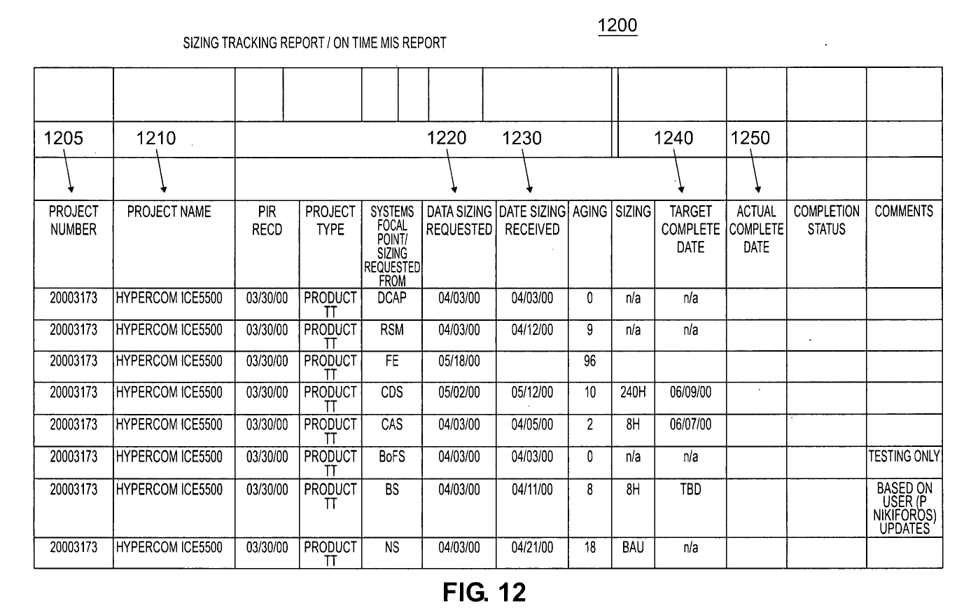

A sample report showing project actual completion date comparison with the project target completion date is illustrated in FIG. 12. Sample report 1200 provides information about projects, such as project numbers in column 1205 and project names in column 1210. Information about project sizing is also provided—such as the date sizing is requested in column 1220 and the date sizing is received in column 1230. In addition, in columns 1240 and 1250, respectively, information is provided showing the target completion date and actual completion date for projects listed in column 1210.

The data from reports 1100 and 1200 enables developers and business groups to better manage subsequent projects as these reports help identify, among other things: (1) project entries whose sizing estimates may have been too aggressive; (2) developers' abilities to set reliable sizing estimates; (3) developers' abilities to meet established sizing estimates; (4) project completion reliability; and the like.

Graphical User Interfaces (GUIs)

In addition to receiving reports, user and/or administrators can attain information regarding project requests that have been submitted to system 100 by accessing one or more available GUIs. A listing of these GUIs is provided in table 1300 of FIG. 3 and include the following views: unsubmitted GUI 1302, pending BFP approval GUI 1304, pending CFO approval GUI 1306, pending PPL approval GUI 1308, pending GUI 1310, rejected GUI 1312, scheduled for daily call GUI 1314, pending sizing GUI 1316, sizing complete GUI 1318, discovery GUI 1320, cancellation GUI 1322 and funding disputed GUI 1324.

Unsubmitted GUI 1302 provides information relating to all PIR forms whose fields have been at least partially populated by a user, but have not been submitted by the user for processing. Such a GUI may be useful for locating and accessing a PIR form that a user has begun to fill in so that the form may be completed and submitted.

Pending BFP approval GUI 1304 provides information relating to PIR forms that have been submitted but are awaiting approval by the BFP. Such a view may be useful if, for example, a BFP seeks to view a list of all project requests that are awaiting approval by that BFP. Similarly, pending CFO approval GUI 1306 and pending PPL approval GUI 1308 provide information relating to PIR forms that have been submitted by a requester but are awaiting approval by a CFO or PPL, respectively. Whereas, pending GUI 1310 provides a listing of PIR forms submitted but pending approval by one or more individuals.

A list of rejected PIR forms may be accessed by rejected GUI 1312. Such a GUI may be used by a requester to, for example, locate and access a PIR form that has been rejected such that the form can be revised for resubmission.

In one instance, regularly scheduled meetings or telephone conferences (called daily calls) are scheduled for evaluating submitted project requests to identify the status of the project request and to identify information that is required to fulfill the received request. Project requests that are to be discussed at the next scheduled daily call are made accessible to PPL's and other administrators via scheduled daily call GUI 1314.

GUIs may also be accessed allowing a requester or administrator to view information relating to project requests that are in different phases of processing. For example, information relating to those requests in which sizing is pending may be accessed via pending sizing GUI 1316 and information relating to those requests in which sizing has been completed may be accessed via sizing complete GUI 1318. In addition, information relating to those requests in which the discovery process is pending may be accessed via discovery GUI 1320.

Finally a list of project requests that have been canceled may be viewed by cancellation field 1322 and those projects in which the amount that is calculated for funding is in dispute by the requester, initiating business area, etc. are listed and may be accessed at funding disputed GUI 1324.

The foregoing merely illustrates the principles of the invention. It will thus be appreciated that those skilled in the art will be able to devise numerous other arrangements which embody the principles of the claimed invention and are thus within its spirit and scope.

1. A method for evaluating a request to process a project, wherein the request includes information relating to processing the project, the method comprising:
receiving a score relating to a level of detail included in the request;
determining, by a processor, a project-related date based, at least in part, upon the score.

2. The method of claim 1, further comprising:
determining whether the score indicates that the level of detail exceeds a predetermined level; and
initiating the processing of the project if the score indicates that the level of detail exceeds the predetermined level.

3. The method of claim 1, further comprising:
determining whether the score indicates that the level of detail exceeds a predetermined level; and
initiating a discovery process if the predetermined level is exceeded, wherein the discovery process relates to gathering additional information relating to the processing of the project for determining a subsequent score.

4. The method of claim 1, wherein the project-related date is a target completion date of the project.

5. A method for categorizing a project defined by a project request, the method comprising:
receiving a first value associated with processing a project request;
receiving a second value associated with determining the first value;
calculating, by a processor, a total processing value for completing the project request, wherein the total processing value is based, at least in part, upon the first value and the second value; and
categorizing, by the processor, the project request based, at least in part, upon the total processing value.

6. The method of claim 5, wherein:
the first value relates to an amount of time for processing the project; and
the second value relates to an amount of time for determining the first value.

7. The method of claim 5, wherein:
the first value relates to a cost for processing the project; and
the second value relates to a cost for determining the first value.

8. The method of claim 5, further comprising:
generating an authorization request for the processing of the project, if the categorizing of the project request meets a predetermined rule.

9. The method of claim 8, wherein the predetermined rule relates to whether the total processing value is greater than a predetermined threshold.

10. The method of claim 10, wherein the predetermined threshold relates to an amount of time to process the project request and determining the first value.

11. The method of claim 10, wherein the predetermined threshold relates to a cost for processing the project request and determining the first value.

12. A method for monitoring the processing of a project, wherein the project is defined by a project request, the method comprising:
receiving a first value associated with processing the project request;
receiving a second value associated with determining the first value;
comparing, by a processor, the second value with an estimated sizing value, wherein the estimated sizing value relates to an estimated value for determining the first value; and
storing comparison information, wherein the comparison information is based, at least in part, upon comparing the estimated sizing value with the second value.

13. The method of claim 12, further comprising:
receiving a project request;
determining an amount of time that transpires between receiving the project request and receiving the first value; and
wherein the second value relates to the amount of time for determining the first value, and the estimated sizing value relates to an estimated amount of time for determining the first value.

14. The method of claim 12, further comprising:
generating a report, wherein the report is based, at least in part, upon the comparison information.

15. A method for monitoring the processing of a project, wherein the project is defined by a project request, the method comprising:
receiving a first value associated with processing a project;
comparing, by a processor, the first value with an estimated processing value, wherein the estimated processing value relates to an estimated value for processing the project request; and
storing comparison information, wherein the comparison information is based upon the comparing of the estimated processing value with the first value.

16. The method of claim 15, further comprising:
generating a report based, at least in part, upon the comparison information.

17. A system for evaluating a request to process a project, wherein the request includes information relating to processing the project, the system comprising:
an interface to receive a score relating to a level of detail included in the request; and
a processor programmed to determine a project-related date based, at least in part, upon the score.

18. The system of claim 17, wherein the processor is further programmed to:
determine whether the score indicates that the level of detail exceeds a predetermined level; and
initiate the processing of the project if the score indicates that the level of detail exceeds the predetermined level.

19. The system of claim 17, wherein the processor is further programmed to:
determine whether the score indicates that the level of detail exceeds a predetermined level; and
initiate a discovery process if the predetermined level is exceeded, wherein the discovery process relates to gathering additional information relating to the processing of the project for determining a subsequent score.

20. The system of claim 17, wherein the project-related date is a target completion date of the project.

21. A system for categorizing a project defined by a project request, the system comprising:
an interface to receive a first value associated with processing a project request, and to receive a second value associated with determining the first value; and
a processor programmed to calculate a total processing value for completing the project request, wherein the total processing value is based, at least in part, upon the first value and the second value, and to categorize the project request based, at least in part, upon the total processing value.

22. The system of claim 21, wherein the first value relates to an amount of time for processing the project and the second value relates to an amount of time for determining the first value.

23. The system of claim 21, wherein the first value relates to a cost for processing the project and the second value relates to a cost for determining the first value.

24. The system of claim 21, wherein the processor is further programmed to generate an authorization request for the processing of the project, if the categorizing of the project request meets a predetermined rule.

25. The system of claim 24, wherein the predetermined rule relates to whether the total processing value is greater than a predetermined threshold.

26. The system of claim 26, wherein the predetermined threshold relates to an amount of time for processing the project request and determining the first value.

27. The system of claim 26, wherein the predetermined threshold relates to a cost for processing the project request and determining the first value.

28. A system for monitoring the processing of a project, wherein the project is defined by a project request, the system comprising:
an interface to receive a first value associated with processing the project request, and for receiving a second value associated with determining the first value;
a processor programmed to compare the second value with an estimated sizing value, wherein the estimated sizing value relates to an estimated value for determining the first value; and
a storage device to store comparison information, wherein the comparison information is based, at least in part, upon comparing the estimated sizing value with the second value.

29. The system of claim 28, wherein:
the interface further receives the project request; and
the processor is further programmed to determine an amount of time that transpires between receiving the project request and receiving the first value; and
wherein the second value relates to the amount of time for determining the first value, and the estimated sizing value relates to an estimated amount of time for determining the first value.

30. The system of claim 28, wherein the processor is further programmed to generate a report, wherein the report is based, at least in part, upon the comparison information.

31. A system for monitoring the processing of a project, wherein the project is defined by a project request, the system comprising:
an interface to receive a first value associated with processing a project;
a processor programmed to compare the first value with an estimated processing value, wherein the estimated processing value relates to an estimated value for processing the project request; and
a storage device to store comparison information, wherein the comparison information is based upon the comparing of the estimated processing value with the first value.

32. The system of claim 31, wherein the processor is further programmed to generate a report based, at least in part, upon the comparison information.
